(19) United States
(12) Patent Application Publication
(10) Pub. No.: US 2007/0103831 A1
(43) Pub. Date: May 10, 2007

(54) Intelligent safety device for vehicle on-board electric equipment

(76) Inventor: Olivier Andrieu, Beynost (FR)

Correspondence Address: DENNISON, SCHULTZ & MACDONALD, 1727 KING STREET, SUITE 105, ALEXANDRIA, VA, 22314, US

(21) Appl. No.: 10/580,430

(22) PCT Filed: Nov. 24, 2004
(86) PCT No.: PCT/FR04/03000

§ 371 Date: Aug. 11, 2006

(30) Foreign Application Priority Data
Nov. 25, 2003 (FR) 0313777

(51) Int. Cl. H02H 3/08

(52) U.S. Cl. 361/93.1

(57) ABSTRACT

The invention relates to a smart safety device appearing as a box (3) including mounting means on at least one electric circuit. The box includes:
at least one sensor (4) for measuring a current flowing on an electric circuit of the network,
a computing and control unit (6) including:
   means (7) for acquiring current measurements taken by the current sensor (4),
   computing means (11) which, depending on current measurements and on determined operating criteria for the electric network, determine the abnormal or normal operating state of at least one piece of electric equipment,
and at least one disconnecting system (15) controlled by the computing and control unit (6) in order to disconnect at least the electric circuit including a piece of electric equipment which is considered to be in an abnormal operating state by said unit.

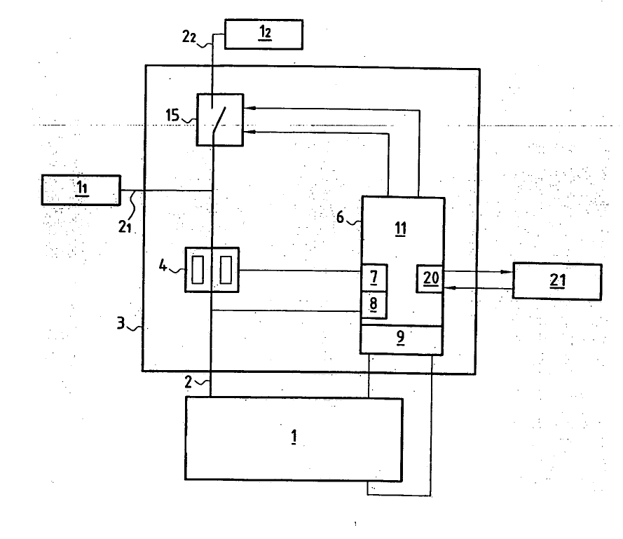

The present invention relates to a safety device associated with a piece of electric equipment on board a vehicle and suitable for checking the electric power of such equipment.

The object of the invention in particular aims at checking the electric power of a piece of equipment forming a source of power such as a battery for example.

In the last few years, the need appeared for checking electric power from the battery on board a vehicle in particular for reasons of safety and reduction in consumption of the vehicle and emissions of carbon dioxide. It was thus suggested to associate a management system with the battery of the vehicle in order to optimize operation of the battery. In this respect, the management system should be aware of the state of charge or discharge of the battery, the charging and discharging history, or the operating mode of the vehicle, i.e., engine either stopped or not, vehicle either underway or stopped. This management system checks the electric power delivered by the battery, specifically to each encountered operating situation such as for example, the existence of an electric discharge with the engine stopped, and strong pulsed discharges for assisted steering or for electromagnetic valves, strong continuous consumption rates for providing defrosting, a slow electric discharge when the vehicle is stopped. This management system is associated with a sensor for measuring the current delivered by the battery as well as with sensors for measuring the voltage and the temperature of the battery.

Such a management system proves to be all the more important when a vehicle integrates more and more pieces of electric equipment. As a result, there is an increase in the network of electric conductors, which leads to risks of breakdowns and/or short circuits. Short circuits of the resistive type thus appear with a current which does not exceed a few tens of amperes, so that the safety fuses cannot play their role. In certain cases, such a short circuit may lead to the destruction of a piece of electric equipment, or even to the onset of a fire. Now, in certain cases, the management system does not allow the electric power delivered by the battery to be checked for notably faults or short circuits occurring on certain pieces of electric equipment.

In order to attempt to detect a short circuit in the electric network of a vehicle, Patent FR 2 831 272 suggests measuring all the currents which pass in the different branches of the electric network of the vehicle via current sensors and proceeding with summing these currents. If the sum of the currents is non zero corresponding to a short circuit, an electronic control box is able to provide disconnecting of the battery. It should be noted that this technique imposes that as many current sensors are applied as there are branches of the electric network. Moreover, it should be considered that the sum of the currents may be zero while a short circuit is present on a circuit of the electric network. Finally, such a system does not allow the electric power delivered by the battery to be checked for short circuits occurring on certain pieces of electric equipment.

The present invention therefore aims at finding a remedy to the drawbacks stated above by proposing a smart safety system, With which the electric power of equipment on board a vehicle may be checked safely.

To achieve such a goal, the invention relates to a smart safety device for at least one piece of electric equipment on board a vehicle, including a network of electric circuits, in which pieces of electric equipment are mounted, at least one of them forming a power source. Such a smart safety device appears as a box including means for mounting it on at least one electric circuit, the box including:
at least one sensor for measuring a current flowing on an electric circuit of the network,
a computing and control unit including:
   means for acquiring current measurements taken by the current sensor,
   computing means which, depending on the current measurements and on determined operating criteria of the electric network, determine the normal or abnormal operating state of at least one piece of electric equipment,
and at least a disconnecting system controlled by the computing and control unit in order to disconnect at least the electric circuit including a piece of electric equipment which is considered to be in an abnormal operating state by said unit.

According to a preferred alternative embodiment, the computing and control unit includes means for acquiring measurements of at least one operating parameter of the power source, such as the voltage delivered by the power source and/or the temperature of the power source.

Advantageously, the disconnecting system is mounted in the circuit of a piece of electric equipment forming a power source, such as an alternator, a battery or a voltage converter.

Preferably, the computing and control unit includes means for communicating with a centralized power source management system.

According to this alternative embodiment, the computing means determine the operating conditions of electric equipment according to the operating state signals of the vehicle, transmitted by the centralized management system.

Advantageously, the computing means determine the operating conditions of the pieces of electric equipment, according to determined operating criteria for the battery, such as predetermined current values corresponding to a short circuit.

For example, the current measurement sensor is of the Hall effect type.

Preferably, the current measurement sensor is mounted in the circuit of a piece of electric equipment forming a power source such as an alternator, a battery or a voltage converter.

According to another alternative embodiment, the current measurement sensor is mounted in the circuit of electric equipment such as on-board computers or lighting sources, the disconnecting system being mounted in such an electric circuit.

Advantageously, the box includes means for mounting a power source on an electric circuit and integrated means for recovering power delivered by the source in order to power various electric components of the box.

According to an advantageous feature of the invention, the disconnecting system is mounted in the electric network outside at least one safety electric circuit.

Preferably, the disconnecting system includes an actuator of the pyrotechnical type.

Various other features will become apparent form the description made below with reference to the single FIGURE which is a functional block diagram showing an exemplary embodiment of a smart safety device according to the invention.

The object of the invention thus relates to a smart safety device for at least one piece of electric equipment 1ᵢ on board a vehicle, in particular an automobile, and including an electric network, a portion of which is only schematized in the single FIGURE. Such an electric network includes electric circuits 2, 2₁, 2₂, . . . in which pieces 1, 1₁, 1₂, etc. of electric equipment are mounted, at least one of which referenced as 1 for example corresponds to a power source such as a battery, an alternator or a voltage converter. Such a device appears as a box 3 including mounting means, not shown, on at least one electric circuit of the network. Such mounting means enable the box 3 for example to be attached onto the end of a cable of a power source, or onto an output lug of the battery.

The box 3 includes at least one sensor 4 for measuring the current flowing on an electric circuit of the network. Advantageously, the current sensor 4 is of the Hall effect type. According to a preferred alternative embodiment, the measurement sensor 4 is mounted in the electric circuit (i.e. 2 in the illustrated example) of a piece of electric equipment corresponding to a power source (reference 1 in the illustrated example).

The box 3 also includes a computing and control unit 6 including means 7 for acquiring current measurements delivered by the current sensor 4. This computing and control unit 6 includes according to a preferred alternative embodiment, means for acquiring measurements of at least one operating parameter of the power source. Preferably, as an operating parameter of the power source such as the battery, provision may be made for taking into account the voltage delivered by the battery and/or the temperature of the battery. According to this preferred alternative embodiment, the computing and control unit 6 includes means 8 for acquiring measurements of the voltage of the power source and means 9 for acquiring measurements of the temperature of the power source.

This computing and control unit 6 also includes computing means 11, depending on determined operating criteria of the electric network and on measurements obtained by the current acquisition means 7 and possibly of the voltage and temperature 8 et 9, determine the operating conditions of at least one piece of electric equipment 1, 1₁, 1₂. In other words the computing and control unit 6 determines the normal or abnormal operating state of a piece of electric equipment. This faulty state is taken into account by considering the electric power flowing on the circuit of such a piece of electric equipment and not the specific functions linked to the electric equipment.

The computing and control unit 6 is capable of controlling at least one disconnecting system 15 also mounted in the box 3. Such a disconnecting system 15 such as a circuit breaker may be an actuator of the pyrotechnical type. Such a disconnecting system 15 is capable of disconnecting the circuit of a piece of electric equipment which is considered to be in an abnormal operating state by the computing and control unit 6.

According to a preferred alternative embodiment, the disconnecting system 15 is mounted in the electric circuit of a piece of electric equipment forming a power source 1. In other words, the disconnecting system 15 is mounted at the output of the power source in order to disconnect the electric power supply of equipment 1₂ mounted downstream from the disconnecting system 15, from the power source 1. Such pieces of electric equipment 1₂ are components for example which consume a lot a power such as the air-conditioning system, electric motors, heating resistors, etc.

According to another exemplary embodiment, the disconnecting system 15 is mounted in the electric circuit 2₂ for powering electric equipment 1₂ such as on-board computers or lighting sources. According to this exemplary embodiment, the measurement sensor 4 may be mounted in the electric circuit 2₂ powering such pieces of equipment, i.e., on-board computers or lighting sources. In this case, at least one piece of electric equipment for example 1₁ is found directly connected to the electric circuit 2 of the power source 1.

According to a preferred alternative embodiment, the disconnecting system 15 is mounted in the electric network outside at least one safety electric circuit 2₁ including at least one piece of safety electric equipment 1₁. In other words, the pieces of electric safety equipment 1₁, such as signal warning lights, vehicle safety systems, etc. are always powered by the power source 1.

The computing and control unit 6 takes into account measurements of current and measurements of temperature and/or voltage of the battery 1. From these measurements and from determined operating criteria for the vehicle such as for example the conjunction of a high charge current and a high battery temperature, or the conjunction of a change in the battery voltage under a charge current, showing the bad state of the battery, the computing means 11 determine whether the electric power supply of one or more pieces of electric equipment 1, 1₂ should be interrupted. If a piece of electric equipment 1, 1₂ should no longer be powered by the power source, the computing and control unit 6 controls the disconnecting system 15 mounted in the associated electric circuit. Insofar that the controlled decision is made at the safety device placed at the output of the power source, the disconnection of the power supply of the desired piece of electric equipment is performed in a safe way. It should be understood that the safety device according to the invention appears as a smart box, with a standalone character, capable of disconnecting the electric circuit(s) associated with the breaker circuit(s) 15 providing complete management of the power delivered by the power source when the latter is equipped at the output of the device according to the invention.

Advantageously, the computing and control unit 6 includes means 20 for communicating with a centralized system 21 for managing the power source. Such a centralized management system 21 is capable of transmitting to the computing and control unit 6 operating state signals of the vehicle such as vehicle either stopped or underway, engine either stopped or running.

The computing means 11 thereby determine the operating conditions of the pieces of electric equipment 1, 1₂ depending on such operating state signals of the vehicle. For example, when the vehicle is in the stopped position, determined operating conditions of the power source may be selected which correspond to searching for an abnormal consumption of current. Above a determined threshold of the current delivered by the battery, the computing and control unit 6 may detect a short circuit and thereby control a disconnecting system 15 associated with the short-circuited electric circuit.

Also, when the vehicle is running, operating conditions of the battery may be selected, for example corresponding to a battery excessively under load and non-recharged, to a breakdown of the alternator, to a used battery, to abnormal consumption, etc. The computing control unit 6 thereby controls the disconnecting system(s) 15 associated with the pieces of electric equipment for which the power supply should be disconnected.

If the box 3 includes means for mounting a power source on an electric circuit, it is advantageous to incorporate into the box 3, integrated means for recovering the power delivered for the power source in order to power the different electric components of the box.

The invention is not limited to the described and illustrated examples as different changes may be made thereto without departing from its scope.

1-12. (canceled)

13. A smart safety device for at least one piece of electric equipment on board a vehicle including a network of electric circuits wherein pieces of electric equipment are mounted, at least one of which forms a power source, characterized in that it appears as a box (3) including mounting means on at least one electric circuit, the box comprising:
at least one sensor (4) for measuring a current flowing on an electric circuit of the network,
a computing and control unit (6) including:
means (7) for acquiring current measurements taken by the current sensor (4),
computing means (11) which, depending on current measurements and on determined operating criteria of the electric network, determine the normal or abnormal operating state of at least one piece of electric equipment,
and at least one disconnecting system (15) controlled by the computing and control unit (6) so as to disconnect at least the electric circuit including a piece of electric equipment which is considered to be in an abnormal operating state by said unit.

14. The smart safety device according to claim 13, wherein the computing and control unit (6) includes means (8, 9) for acquiring measurements of at least one operating parameter of the power source, such as the voltage delivered by the power source and/or the temperature of the power source.

15. The smart safety device according to claim 13, wherein the disconnecting system (15) is mounted in the circuit of a piece of electric equipment forming a power source.

16. The smart safety device according to claim 13, wherein the computing and control unit (6) includes means (20) for communicating with a centralized system (21) for managing a power source.

17. The smart safety device according to claim 16, wherein the computing means (11) determine the operating conditions of the pieces of electric equipment (1, 1₂) according to the operating state signals of the vehicle transmitted by the centralized management system (21).

18. The smart safety device according to claim 13, wherein the computing means (11) determine the operating conditions of the pieces of electric equipment (1, 1₂), according to determined operating criteria for the battery such as predetermined current values corresponding to a short circuit.

19. The smart safety device according to claim 13, wherein the current measurement sensor (4) is of the Hall effect type.

20. The smart safety device according to claim 13, wherein the current measurement sensor (4) is mounted in the circuit of a piece of electric equipment (1) forming a power source.

21. The smart safety device according to claim 13, wherein the current measurement sensor (4) is mounted in the circuit (2₂) of pieces of electric equipment (1₂) such as on-board computers or lighting sources, the disconnecting system (15) being mounted in such an electric circuit (2₂).

22. The smart safety device according to claim 13, wherein the box (3) includes means for mounting power source (1) on an electric circuit and integrated means for recovering power delivered by the source in order to power different electric components of the box.

23. The smart safety device according to claim 13, wherein the disconnecting system (15) is mounted in the electric network outside at least one safety electric circuit (1₁).

24. The smart safety device according to claim 13, wherein the disconnecting system (15) is an actuator of the pyrotechnical type.

25. The smart safety device according to claim 15, wherein the power source is selected from the group consisting of an alternator, a battery and a voltage converter.

26. The smart safety device according to claim 20, wherein the power source is selected from the group consisting of an alternator, a battery and a voltage converter.
